(19) United States
(12) Patent Application Publication
(10) Pub. No.: US 2019/0226843 A1
(43) Pub. Date: Jul. 25, 2019

(54) Multi-Functional Level Ruler

(71) Applicant: Chunyang Zhang, Erie, PA (US)

(72) Inventor: Chunyang Zhang, Erie, PA (US)

(21) Appl. No.: 16/258,385

(22) Filed: Jan. 25, 2019

(30) Foreign Application Priority Data
Jan. 25, 2018 (CN) 207798095U

(51) Int. Cl. G01C 9/02; G01C 9/24; G01B 3/10

(52) U.S. Cl. CPC G01C 9/02; G01B 2003/103; G01B 3/1005; G01C 9/24

(57) ABSTRACT

Related is a measuring tool, and particularly is a multi-functional level ruler. The multi-functional level ruler comprises a box body, the box body is internally mounted with a ruler-returning spring and a tape measure, the ruler-returning spring is wound on a shaft inside the box body, the tape measure is connected with the ruler-returning spring and wound on the ruler-returning spring, one end that is on a right side plate of the box body and close to a back side plate is provided with an opening, one end of the tape measure is provided with a stopper, the tape measure is run out of the opening, and the stopper is located at the opening; the back side plate of the box body is provided with a suction pad, a position that is on a bottom plate of the box body and close to the opening is hinged with a straight ruler, a top plate of the box body is provided with a groove, a counterweight is arranged in the groove, a position that is on the top plate of the box body and close to the opening is provided with a hanging shaft, and the counterweight is connected on the hanging shaft through a suspension wire. The multi-functional level ruler is simple in structure and convenient to carry, and capable of solving a problem that a photo frame is tilted during installation, therefore, the multi-functional level ruler is applicable to installation of photo frames of different sizes; also, the multi-functional level ruler can be used by one person to solve different horizontality problems, saving time and labour.

### TECHNICAL FIELD

The utility model relates to a measuring tool, and particularly to a multi-functional level ruler.

### BACKGROUND

A photo frame wall is one very popular household decoration in recent years and also is one technique for modern persons to pursue fashionable and unique household decorations. The decoration effect of the photo frame wall is closely related to the quality of photo frame installation. Different people may have different installation effects. If an auxiliary tool can be used during installation, the installation of the photo frame may be more orderly, and installation time may also be saved.

However, at present, there is no appropriate auxiliary tool available for photo frame installation on the market. Although a distance between photo frames may be measured by using a straight ruler or a tape measure, the photo frame may be still tilted because no attention is paid to a problem of horizontality, resulting in that the decoration effect is greatly reduced. In addition, when measuring is performed for photo frames of large sizes during an installation process, two persons are required to cooperate with each other to finish the installation work, leading to wastes of manpower.

Further, it is also desired to pay attention to the problem of horizontality in other places in the fields of buildings and life. Therefore, how to design a multi-functional level ruler that is convenient for people to use becomes a technical problem to be solved.

### SUMMARY

To overcome the above shortcomings in the prior art, the utility model provides a multi-functional level ruler, which is simple in structure and convenient to carry. The level ruler is capable of solving a problem that a photo frame is tilted during installation, and therefore is applicable to the installation of photo frames of different sizes. Also, the level ruler can be used by one person, saving time and labour, and solving different horizontality problems.

A technical solution provided by the utility model to solve the technical problem will be described as follows.

The multi-functional level ruler may include a box body, where the box body may include a top plate, a bottom plate, a front side plate, a back side plate, a left side plate and a right side plate, the box body is internally mounted with a ruler-returning spring and a tape measure, the ruler-returning spring is wound on a shaft inside the box body, the tape measure is connected with the ruler-returning spring and wound on the ruler-returning spring, one end that is on the right side plate of the box body and close to the back side plate is provided with an opening, one end of the tape measure is provided with a stopper, the tape measure is run out of the opening, and the stopper is located at the opening.

The back side plate of the box body is provided with a suction pad, a position that is on the bottom plate of the box body and close to the opening is hinged with a straight ruler, the top plate of the box body is provided with a groove, a counterweight is arranged in the groove, a position that is on the top plate of the box body and close to the opening is provided with a hanging shaft, and the counterweight is connected to the hanging shaft through a suspension wire.

The straight ruler is internally provided with an installation groove, the installation groove is internally provided with a telescoping ruler, and a surface of the telescoping ruler is provided with a scale bar.

The bottom plate is provided with a receiving slot, and the straight ruler is mounted in the receiving slot.

At least one suction pad is provided.

An outer edge of the groove is connected with a safety clip through a rotary shaft.

The stopper is provided with a horizontal bubble level.

The counterweight is in a flat shape.

A working principle and a process will be described below.

When the multi-functional level ruler is used, firstly, the counterweight is taken out by opening the safety clip; then, the straight ruler is rotated out from the receiving slot and adjusted to be parallel with the suspension wire, and then the multifunctional level ruler is fixed on a wall surface by using the suction pad of the back side plate. The tape measure is pulled out and adjusted to be horizontal.

If a length of a horizontal side of a measured photo frame is a and a length of a vertical side is b, a position of a fixing point in a horizontal direction can be determined by the tape measure, and a position of a fixing point in a vertical direction can be determined by the straight ruler.

The straight ruler is internally provided with an installation groove, the installation groove is internally mounted with a telescoping ruler, and a surface of the telescoping ruler is provided with a scale bar. The telescoping ruler can be arranged in such a way that an application requirement of large-size photo frames can be satisfied.

The bottom plate is provided with a receiving slot, and the straight ruler is mounted in the receiving slot. The straight ruler may be rotated out when the straight ruler is to be used, and rotated into the receiving slot when the straight ruler is not used, and thus carrying is facilitated.

At least one suction pad is provided to ensure that the multi-functional level ruler is firmly fixed on the wall surface.

The outer edge of the groove is connected with the safety clip through the rotary shaft. The safety clip may be arranged in such a way that the counterweight can be prevented from being released from the groove when the counterweight is not in use.

The stopper is provided with a horizontal bubble level that helps to adjust the tape measure to be in a horizontal state.

The counterweight is in a flat shape, facilitating being embedded into the groove.

Compared with the prior art, beneficial effects of the utility model will be described below.

1. The multi-functional level ruler of the utility model is provided with a receiving slot, so that the straight ruler may be rotated out from the receiving slot when the straight ruler is to be used and rotated into the receiving slot when the straight ruler is not in use. The counterweight may be taken out when the counterweight is to be used and put back into the groove when the counterweight is not in use, and thus carrying is facilitated.

2. The multi-functional level ruler of the utility model may solve a problem that a photo frame is tilted during installation, so that the position of the fixing point of the photo frame can be easily determined during installation. In this way, the installation position is in good order and the decoration effect is good.

3. The multi-functional level ruler of the utility model is provided with a telescoping ruler, which is applicable to the installation of photo frames of different sizes. Also, the level ruler can be used by one person, saving time and manpower.

4. The multi-functional level ruler of the utility model may also solve a plurality of horizontality problems, and can be used to replace an ordinary level ruler.

### BRIEF DESCRIPTION OF DRAWINGS

FIG. 1 is a schematic diagram illustrating a surface structure of a multi-functional level ruler according to an example of the utility model.

FIG. 2 is a schematic diagram illustrating a sectional structure of a multi-functional level ruler according to an example of the utility model.

FIG. 3 is a schematic diagram illustrating a structure of a bottom plate of a multi-functional level ruler according to an example of the utility model.

FIG. 4 is a schematic diagram illustrating a structure of a top plate of a multi-functional level ruler according to an example of the utility model.

FIG. 5 is a schematic diagram illustrating a using state of a multi-functional level ruler according to an example of the utility model.

In the drawings, 1. Box body, 2. opening, 3. ruler-returning spring, 4. tape measure, 5. stopper, 6. suction pad, 7. straight ruler, 8. receiving slot, 9. groove, 10. counterweight, 11. hanging shaft, 12. suspension wire, 13. safety clip, 14. telescoping ruler.

### DETAILED DESCRIPTION

Examples of the utility model will be further described below in combination with the accompanying drawings.

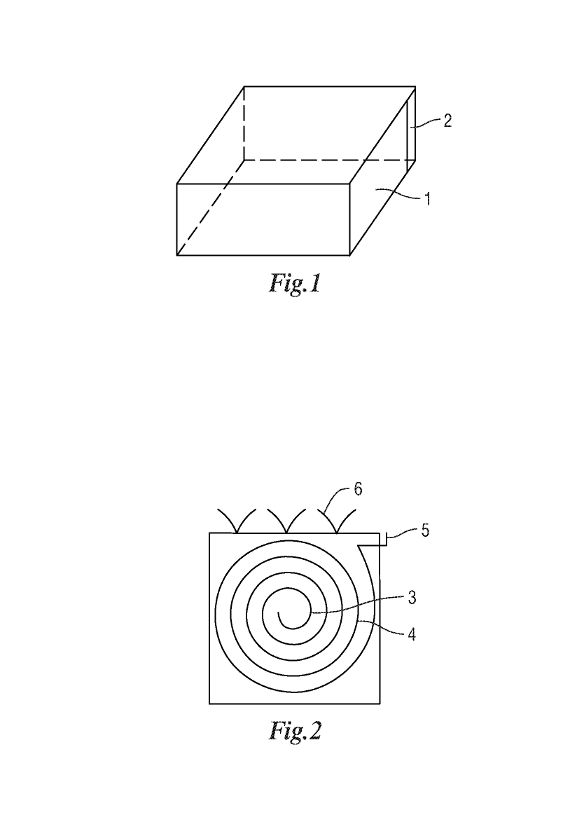

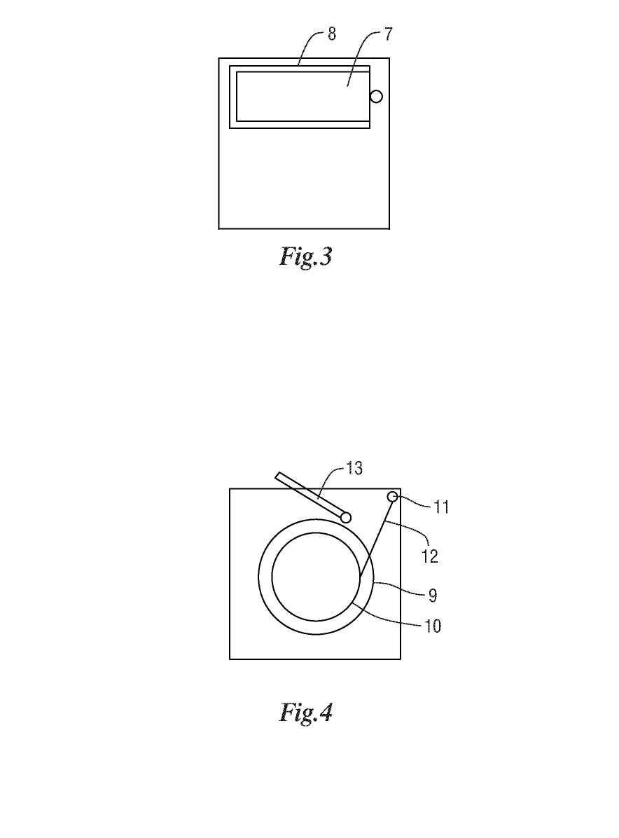

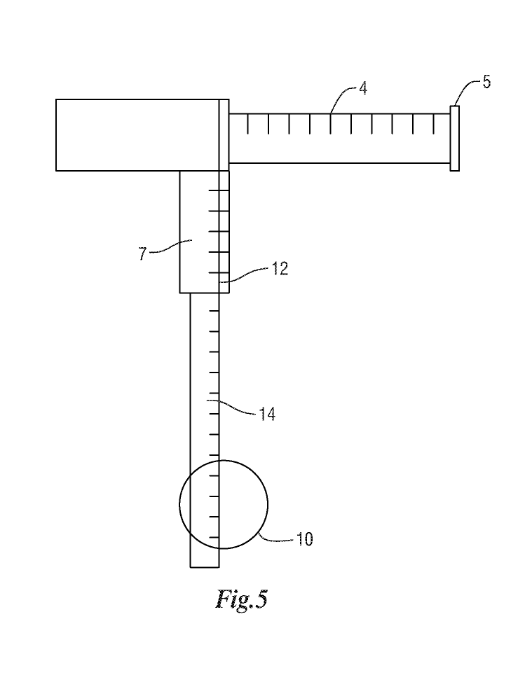

As shown in FIGS. 1-5, the multi-functional level ruler includes a box body 1, where the box body 1 includes a top plate, a bottom plate, a front side plate, a back side plate, a left side plate and a right side plate, the box body 1 is internally mounted with a ruler-returning spring 3 and a tape measure 4, the ruler-returning spring 3 is wound on a shaft inside the box body 1, the tape measure 4 is connected with the ruler-returning spring 3 and wound on the ruler-returning spring 3, one end that is on the right side plate of the box body 1 and close to the back side plate is provided with an opening 2, one end of the tape measure 4 is provided with a stopper 5, the tape measure 4 is run out of the opening 2, and the stopper 5 is located at the opening 2.

The back side plate of the box body 1 is provided with a suction pad 6, a position that is on the bottom plate of the box body 1 and close to the opening 2 is hinged with a straight ruler 7, the top plate of the box body 1 is provided with a groove 9, a counterweight 10 is arranged in the groove 9, a position that is on the top plate of the box body 1 and close to the opening 2 is provided with a hanging shaft 11, and the counterweight 10 is connected to the hanging shaft 11 through a suspension wire 12.

The straight ruler 7 is internally provided with an installation groove, the installation groove is internally mounted with a telescoping ruler 14, and a surface of the telescoping ruler 14 is provided with a scale bar.

The bottom plate is provided with a receiving slot 8, and the straight ruler 7 is mounted in the receiving slot 8.

At least one suction pad 6 is provided.

An outer edge of the groove 9 is connected with a safety clip 13 through a rotary shaft.

The stopper 5 is provided with a horizontal bubble level.

The counterweight 10 is in a flat shape.

When the multi-functional level ruler is used, firstly, the counterweight 10 is taken out by opening the safety clip 13; then, the straight ruler 7 is rotated out from the receiving slot 8 and adjusted to be parallel with the suspension wire 12, and then the multi-functional level ruler is fixed on a wall surface by using the suction pad on the back side plate. The tape measure 4 is pulled out and adjusted to be horizontal.

If a length of a horizontal side of a measured photo frame is a and a length of a vertical side is b, a position of a fixing point in a horizontal direction may be determined by the tape measure 4, and a position of a fixing point in a vertical direction may be determined by the straight ruler 7.

The straight ruler 7 is internally provided with an installation groove, the installation groove is internally mounted with the telescoping ruler 14, and a surface of the telescoping ruler 14 is provided with a scale bar. The telescoping ruler 14 may be arranged in such a way that an application requirement of large-size photo frames can be satisfied.

The bottom plate is provided with the receiving slot 8, and the straight ruler 7 is mounted in the receiving slot 8. The straight ruler may be rotated out from the receiving slot 8 when it is to be used and rotated into the receiving slot 8 when it is not in use, and thus carrying is facilitated.

At least one suction pad 6 is provided to ensure that the multi-functional level ruler is firmly fixed on the wall surface.

The outer edge of the groove 9 is connected with the safety clip 13 through the rotary shaft. The safety clip 13 may be arranged in such a way that the counterweight 10 can be prevented from being released from the groove 9 when the counterweight is not in use.

The stopper 5 is provided with a horizontal bubble level that helps to adjust the tape measure 4 to be in a horizontal state.

The counterweight 10 is in a flat shape, facilitating being embedded into the groove 9.

1. A multi-functional level ruler, comprising:
a box body, wherein said box body comprises a top plate, a bottom plate, a front side plate, a back side plate, a left side plate and a right side plate;
said box body is internally mounted with a ruler-returning spring and a tape measure;
said ruler-returning spring is wound on a shaft inside said box body;
said tape measure is connected with said ruler-returning spring and wound on said ruler-returning spring;
an opening is provided on said box body;
one end of said tape measure is provided with a stopper, said tape measure is run out of said opening, and said stopper is located at said opening;
said back side plate is provided with a suction pad;
a hinged straight ruler is provided on said bottom plate;
said top plate is provided with a groove;
a counterweight is arranged in said groove;
a hanging shaft is provided on said top plate; and
said counterweight is connected to said hanging shaft with a suspension wire.

2. The multi-functional level ruler of claim 1, wherein said straight ruler is internally provided with an installation groove, said installation groove is internally mounted with a telescoping ruler, and a surface of said telescoping ruler is provided with a scale bar.

3. The multi-functional level ruler of claim 1, wherein said bottom plate is provided with a receiving slot and said straight ruler is installed in said receiving slot.

4. The multi-functional level ruler of claim 1, wherein said back plate is provided with more than one said suction pad.

5. The multi-functional level ruler of claim 1, wherein an outer edge of said groove is connected with a safety clip through a rotary shaft.

6. The multi-functional level ruler of claim 1, wherein said stopper is provided with a horizontal bubble level.
